(19) United States
(12) Patent Application Publication
(10) Pub. No.: US 2025/0087729 A1
(43) Pub. Date: Mar. 13, 2025

(54) METAL-AIR FLOW BATTERY CHARGING CELL

(71) Applicant: SHARP KABUSHIKI KAISHA, Sakai City (JP)

(72) Inventors: SHINOBU TAKENAKA, Sakai City (JP); HIROTAKA MIZUHATA, Sakai City (JP)

(21) Appl. No.: 18/882,533

(22) Filed: Sep. 11, 2024

(30) Foreign Application Priority Data
Sep. 12, 2023 (JP) 2023-147253

(51) Int. Cl. H01M 8/04186; H01M 4/86; H01M 8/18; H01M 12/08; H01M 16/00

(52) U.S. Cl. CPC H01M 8/04186; H01M 4/86; H01M 8/188; H01M 12/08; H01M 16/003; H01M 2250/402

(57) ABSTRACT

A metal-air flow battery charging cell comprises a first layer including a first flow path formed therein; a positive electrode facing the first flow path; a second layer including a second flow path formed therein; a negative electrode facing the second flow path; a separator configured to separate the first flow path and the second flow path from each other; a positive-electrode liquid that flows in the first flow path, the positive-electrode liquid having a first viscosity; and a negative-electrode liquid that flows in the second flow path, the negative-electrode liquid having a second viscosity that is higher than the first viscosity.

### CROSS-REFERENCE TO RELATED APPLICATION

The present application claims priority from Japanese Application JP2023-147253, the content of which is hereby incorporated by reference into this application.

### BACKGROUND

### 1. Field

The present disclosure relates to metal-air flow battery charging cells.

### Description of Embodiments

U.S. Pat. No. 7,470,351 discloses a system for producing metal particles. In this system, metal particles are produced on the surface of a cathode by electrolysis of a solution containing dissolved metal. The produced metal particles are removed from the surface of the cathode by using a scraper or another suitable means when the metal particles have grown to a sufficient size (paragraphs 0014 and 0057).

### SUMMARY

In the system disclosed in U.S. Pat. No. 7,470,351, the scraper or other suitable means needs to be moved along the surface of the cathode to remove the metal particles from the surface of the cathode. The system entails problems such as consumption of electric power required to move the scraper or other suitable means and reduced durability due to the motion of the scraper or other suitable means along the surface of the cathode.

The present disclosure, in one aspect thereof, has been made in view of these problems. The present disclosure, in one aspect thereof, has an object to provide, for example, a metal-air flow battery charging cell that exhibits high durability because the metal-air flow battery charging cell allows detaching negative-electrode active material particles from a negative electrode without having to consume large electric power and hence does not require physical contact with, for example, a scraper.

The present disclosure, in one aspect thereof, is directed to a metal-air flow battery charging cell including: a first layer including a first flow path formed therein; a positive electrode facing the first flow path; a second layer including a second flow path formed therein; a negative electrode facing the second flow path; a separator configured to separate the first flow path and the second flow path from each other; a positive-electrode liquid that flows in the first flow path, the positive-electrode liquid having a first viscosity; and a negative-electrode liquid that flows in the second flow path, the negative-electrode liquid having a second viscosity that is higher than the first viscosity.

### BRIEF DESCRIPTION OF THE DRAWINGS

FIG. 1 is a schematic diagram of a metal-air flow battery in accordance with Embodiment 1.

FIG. 2 is a schematic exploded perspective view of a charge cell included in the metal-air flow battery in accordance with Embodiment 1.

FIG. 3 is a schematic cross-sectional view of the charge cell included in the metal-air flow battery in accordance with Embodiment 1.

FIG. 4A is a graph representing a first control example for the current value of an electric current flowing between a positive and a negative electrode of the charge cell included in the metal-air flow battery in accordance with Embodiment 1.

FIG. 4B is a graph representing a first control example for the flow rate of a negative-electrode liquid in a second flow path in the charge cell included in the metal-air flow battery in accordance with Embodiment 1.

FIG. 5A is a graph representing a second control example for the current value of an electric current flowing between a positive and a negative electrode of the charge cell included in the metal-air flow battery in accordance with Embodiment 1.

FIG. 5B is a graph representing a second control example for the flow rate of a negative-electrode liquid in the second flow path in the charge cell included in the metal-air flow battery in accordance with Embodiment 1.

FIG. 6A is a graph representing a third control example for the current value of an electric current flowing between a positive and a negative electrode of the charge cell included in the metal-air flow battery in accordance with Embodiment 1.

FIG. 6B is a graph representing a third control example for the flow rate of a negative-electrode liquid in the second flow path in the charge cell included in the metal-air flow battery in accordance with Embodiment 1.

FIG. 7 is a graph representing a fourth control example for the current value of an electric current flowing between a positive and a negative electrode of the charge cell included in the metal-air flow battery in accordance with Embodiment 1.

FIG. 8 is a graph representing a fifth control example for the flow rate of a negative-electrode liquid in the second flow path in the charge cell included in the metal-air flow battery in accordance with Embodiment 1.

FIG. 9 is a schematic cross-sectional view of a charge cell included in a metal-air flow battery in accordance with a first variation example of Embodiment 1.

FIG. 10 is a schematic cross-sectional view of a charge cell included in a metal-air flow battery in accordance with a second variation example of Embodiment 1.

FIG. 11 is a schematic cross-sectional view of a charge cell included in a metal-air flow battery in accordance with a third variation example of Embodiment 1.

FIG. 12 is a schematic cross-sectional view of a charge cell included in a metal-air flow battery in accordance with a fourth variation example of Embodiment 1.

FIG. 13 is a schematic cross-sectional view of a charge cell stack that can be used in place of the charge cell included in the metal-air flow battery in accordance with Embodiment 1.

### DESCRIPTION OF EMBODIMENTS

The following will describe embodiments of the present disclosure with reference to drawings. Identical and equivalent elements in the drawings are denoted by the same reference numerals, and description thereof is not repeated.

### Embodiment 1

### 1.1 Metal-Air Flow Battery

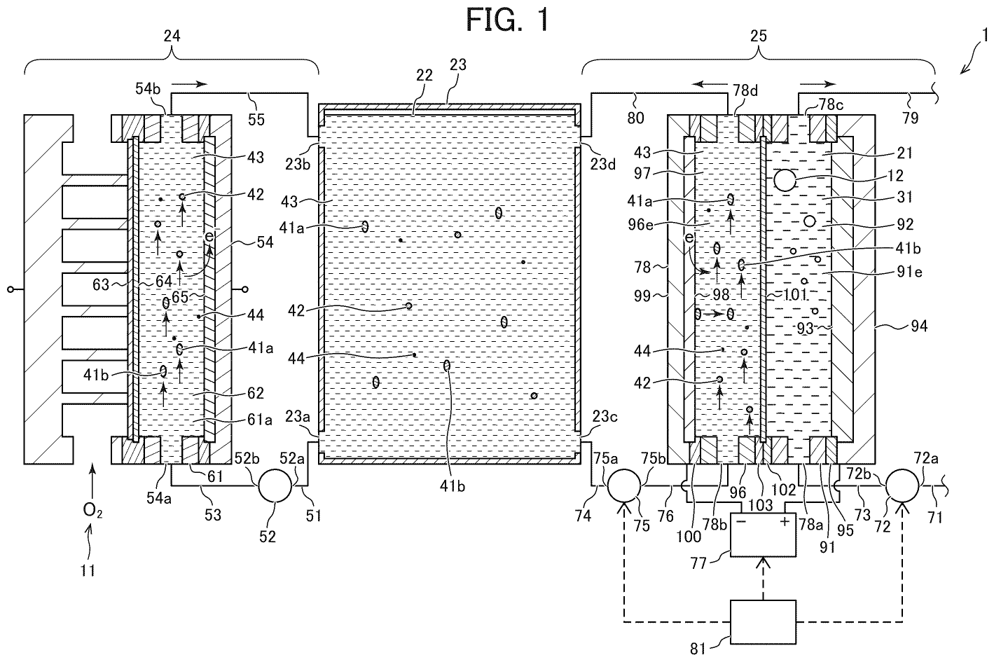

FIG. 1 is a schematic diagram of a metal-air flow battery in accordance with Embodiment 1.

A metal-air flow battery 1 in accordance with Embodiment 1, shown in FIG. 1, absorbs gaseous oxygen 11 from ambient air of the metal-air flow battery 1 upon electric discharge. The metal-air flow battery 1 releases gaseous oxygen 12 into the ambient air of the metal-air flow battery 1 upon electric charge.

The metal-air flow battery 1 is a zinc-air flow battery. Therefore, the metal-air flow battery 1 uses a zinc species as the negative-electrode active material. It should be understood however that the metal-air flow battery 1 may be any metal-air flow battery other than a zinc-air flow battery. Therefore, the metal-air flow battery 1 may use a metal species other than a zinc species as the negative-electrode active material. The metal species other than a zinc species may be, for example, a cadmium species, a lithium species, a sodium species, a magnesium species, a lead species, a tin species, an aluminum species, or an iron species. The metal in the metal species may contain either only a metal that is the primary component or an alloy of a metal that is a primary component and a secondary component. The metal species may be either a metal or an oxide. Whether the metal species is a metal or an oxide is dictated by the progress of discharge reaction or charge reaction.

Referring to FIG. 1, the metal-air flow battery 1 includes a positive-electrode liquid 21, a negative-electrode liquid 22, a storage unit 23, a discharge unit 24, and a charge unit 25.

### 1.2 Positive-Electrode Liquid

Referring to FIG. 1, the positive-electrode liquid 21 contains a first electrolytic solution 31.

The first electrolytic solution 31 is an aqueous solution of potassium hydroxide. The first electrolytic solution 31 may be any aqueous solution other than an aqueous solution of potassium hydroxide and may be any non-aqueous electrolytic solution.

The water contained in the first electrolytic solution 31 is a reactant in the charge reaction that occurs in the charge unit 25.

### 1.3 Negative-Electrode Liquid

Referring to FIG. 1, the negative-electrode liquid 22 contains reduced negative-electrode active material particles 41a, oxidized negative-electrode active material particles 41b, negative-electrode active material ions 42, and a second electrolytic solution 43.

As described above, the metal-air flow battery 1 is a zinc-air flow battery. Therefore, the reduced negative-electrode active material particles 41a, the oxidized negative-electrode active material particles 41b, and the negative-electrode active material ions 42 are zinc species. The reduced negative-electrode active material particles 41a are metal zinc (Zn) particles, and the oxidized negative-electrode active material particles 41b are zinc oxide (ZnO) particles. The reduced negative-electrode active material particles 41a and the oxidized negative-electrode active material particles 41b are dispersed in the second electrolytic solution 43. Therefore, the negative-electrode liquid 22 has slurry-like properties. The reduced negative-electrode active material particles 41a have a particle diameter of, for example, a few micrometers, and the oxidized negative-electrode active material particles 41b have a particle diameter of, for example, a few tens to a few hundreds of nanometers. The negative-electrode active material ions 42 are zincate ions (Zn(OH)₄²⁻) and dissolved in the second electrolytic solution 43.

The second electrolytic solution 43 is an aqueous solution of potassium hydroxide. The second electrolytic solution 43 may be any aqueous solution other than an aqueous solution of potassium hydroxide and may be any non-aqueous electrolytic solution.

The negative-electrode active material ions 42 are a reactant in the charge reaction that occurs in the charge unit 25. The reduced negative-electrode active material particles 41a are a product of the charge reaction that occurs in the charge unit 25.

### 1.4 Storage Unit

The storage unit 23 stores the negative-electrode liquid 22. The storage unit 23 has an outlet port 23a, an inlet port 23b, an outlet port 23c, and an inlet port 23d. The outlet port 23a and the outlet port 23c allow the negative-electrode liquid 22 to flow out. The inlet port 23b and the inlet port 23d allow the negative-electrode liquid 22 to flow in.

### 1.5 Discharge Unit

The discharge unit 24 absorbs the gaseous oxygen 11 from ambient air of the discharge unit 24. The negative-electrode liquid 22 flows into the discharge unit 24 from the storage unit 23. The discharge unit 24 causes the absorbed gaseous oxygen 11 and the incoming negative-electrode liquid 22 to be involved in discharge reaction for the generation of discharging electric power and further causes the negative-electrode liquid 22 involved in the discharge reaction to flow out to the storage unit 23. The discharge unit 24 causes the gaseous oxygen 11 and the reduced negative-electrode active material particles 41a contained in the negative-electrode liquid 22 to be involved in the discharge reaction, thereby consuming the reduced negative-electrode active material particles 41a, to produce the negative-electrode active material ions 42.

Referring to FIG. 1, the discharge unit 24 includes a pipe 51, a pump 52, a pipe 53, a discharge cell 54, and a pipe 55.

The pipe 51 guides the negative-electrode liquid 22 from the outlet port 23a of the storage unit 23 to an inlet port 52a of the pump 52. The pipe 51 hence causes the negative-electrode liquid 22 flowing out of the outlet port 23a to flow into the inlet port 52a.

The pump 52 causes the negative-electrode liquid 22 flowing into the inlet port 52a of the pump 52 to flow out of an outlet port 52b of the pump 52. In doing so, the pump 52 generates a flow of the negative-electrode liquid 22. The pump 52 hence feeds the negative-electrode liquid 22 from the storage unit 23 to the discharge cell 54.

The pipe 53 guides the negative-electrode liquid 22 from the outlet port 52b of the pump 52 to an inlet port 54a of the discharge cell 54. The pipe 53 hence causes the negative-electrode liquid 22 flowing out of the outlet port 52b to flow into the inlet port 54a.

The discharge cell 54 absorbs the gaseous oxygen 11 from ambient air of the discharge cell 54. The discharge cell 54 causes the negative-electrode liquid 22 flowing into the inlet port 54a of the discharge cell 54 to flow out of an outlet port 54b of the discharge cell 54. In doing so, the discharge cell 54 causes the absorbed gaseous oxygen 11 and the incoming negative-electrode liquid 22 to be involved in discharge reaction and further causes the negative-electrode liquid 22 involved in the discharge reaction to flow out of the outlet port 54b. The discharge cell 54 outputs the discharging electric power generated in the discharge reaction.

The pipe 55 guides the negative-electrode liquid 22 from the outlet port 54b of the discharge cell 54 to the inlet port 23b of the storage unit 23. The pipe 55 hence causes the negative-electrode liquid 22 flowing out of the outlet port 54b to flow into the inlet port 23b.

### 1.6 Discharge Cell

Referring to FIG. 1, the discharge cell 54 includes a layer 61, a negative-electrode liquid 62, a positive electrode 63, a separator 64, and a negative electrode 65.

There is formed a flow path 61a in the layer 61. The flow path 61a extends from the inlet port 54a of the discharge cell 54 to the outlet port 54b of the discharge cell 54. The flow path 61a therefore passes the negative-electrode liquid 22 flowing into the inlet port 54a and allows the passing negative-electrode liquid 22 to flow out of the outlet port 54b.

The negative-electrode liquid 62 flows in the flow path 61a in the layer 61. The negative-electrode liquid 62 is part of the negative-electrode liquid 22 in the metal-air flow battery 1.

The positive electrode 63 is in contact with ambient air of the discharge cell 54. The positive electrode 63 is hence fed with the gaseous oxygen 11 contained in the ambient air of the discharge cell 54. This specific arrangement allows for the reduction reaction of oxygen of chemical equation (1) occurring on the positive electrode 63.

$${O}_{2} + 2 {H}_{2} O + 4 {e}^{-} \to 4 {OH}^{-} \qquad ( 1 )$$

The positive electrode 63 faces the flow path 61a in the layer 61 via the separator 64. The positive electrode 63 hence exchanges OH⁻, which is a product of the reduction reaction of oxygen of chemical equation (1), with the negative-electrode liquid 62 flowing in the flow path 61a via the separator 64.

The negative electrode 65 faces the flow path 61a in the layer 61. The negative electrode 65 hence is in contact with the negative-electrode liquid 62 flowing in the flow path 61a. This specific arrangement allows for oxidation reaction of metal zinc of chemical equations (2) and (3) occurring on the negative electrode 65.

$$Zn + 4 {OH}^{-} \to Zn {( OH )}_{{4}^{2 -}} + 2 {e}^{-} \qquad ( 2 )$$

$$Zn {( OH )}_{{4}^{2 -}} \to ZnO + {H}_{2} O + 2 {OH}^{-} \qquad ( 3 )$$

The total reaction of chemical equation (4) occurs in the discharge cell 54 owing to the reduction reaction of oxygen on the positive electrode 63 and the oxidation reaction of metal zinc on the negative electrode 65.

$$2 Zn + {O}_{2} \to 2 ZnO \qquad ( 4 )$$

Therefore, the discharge cell 54 discharges when the metal zinc changes to zinc oxide.

### 1.7 Charge Unit

The negative-electrode liquid 22 flows from the storage unit 23 into the charge unit 25. The charge unit 25 causes the incoming negative-electrode liquid 22 to be involved in the charge reaction in which the negative-electrode liquid 22 is reproduced and further causes the negative-electrode liquid 22 involved in the charge reaction to flow out to the storage unit 23. The charge unit 25 causes the negative-electrode active material ions 42 contained in the negative-electrode liquid 22 to be involved in the charge reaction, thereby consuming the negative-electrode active material ions 42, to produce the reduced negative-electrode active material particles 41a.

Referring to FIG. 1, the charge unit 25 includes a pipe 71, a pump 72, a pipe 73, a pipe 74, a pump 75, a pipe 76, a power supply 77, a charge cell 78, a pipe 79, a pipe 80, and a control circuit 81.

The pipe 71 guides the positive-electrode liquid 21 from a supply source (not shown) of the positive-electrode liquid 21 to an inlet port 72a of the pump 72. The pipe 71 hence causes the positive-electrode liquid 21 flowing out of the supply source of the positive-electrode liquid 21 to flow into the inlet port 72a.

The pump 72 causes the positive-electrode liquid 21 flowing into the inlet port 72a of the pump 72 to flow out of an outlet port 72b of the pump 72. In doing so, the pump 72 generates a flow of the positive-electrode liquid 21. The pump 72 hence feeds the positive-electrode liquid 21 from the supply source of the positive-electrode liquid 21 to the charge cell 78.

The pipe 73 guides the positive-electrode liquid 21 from the outlet port 72b of the pump 72 to an inlet port 78a of the charge cell 78. The pipe 73 hence causes the positive-electrode liquid 21 flowing out of the outlet port 72b to flow into the inlet port 78a.

The pipe 74 guides the negative-electrode liquid 22 from the outlet port 23c of the storage unit 23 to an inlet port 75a of the pump 75. The pipe 74 hence causes the negative-electrode liquid 22 flowing out of the outlet port 23c to flow into the inlet port 75a.

The pump 75 causes the negative-electrode liquid 22 flowing into the inlet port 75a of the pump 75 to flow out of an outlet port 75b of the pump 75. In doing so, the pump 75 generates a flow of the negative-electrode liquid 22. The pump 75 hence feeds the negative-electrode liquid 22 from the storage unit 23 to the charge cell 78.

The pipe 76 guides the negative-electrode liquid 22 from the outlet port 75b of the pump 75 to an inlet port 78b of the charge cell 78. The pipe 76 hence causes the negative-electrode liquid 22 flowing out of the outlet port 75b to flow into the inlet port 78b.

The power supply 77 inputs charging electric power to the charge cell 78.

The charge cell 78 causes the positive-electrode liquid 21 flowing into the inlet port 78a of the charge cell 78 to flow out of an outlet port 78c of the charge cell 78 and further causes the negative-electrode liquid 22 flowing into the inlet port 78b of the charge cell 78 to flow out of an outlet port 78d of the charge cell 78. In doing so, the charge cell 78 causes the incoming positive-electrode liquid 21 and the incoming negative-electrode liquid 22 to be involved in the charge reaction caused by the charging electric power, causes the positive-electrode liquid 21 involved in the charge reaction to flow out of the outlet port 78c, causes the negative-electrode liquid 22 involved in the charge reaction to flow out of the outlet port 78d, and releases the gaseous oxygen 12 produced in the charge reaction into the ambient air of the charge cell 78.

The pipe 79 guides the positive-electrode liquid 21 from the outlet port 78c of the charge cell 78 to the supply source of the positive-electrode liquid 21. The pipe 79 hence causes the positive-electrode liquid 21 flowing out of the outlet port 78c to flow into the supply source of the positive-electrode liquid 21.

The pipe 80 guides the negative-electrode liquid 22 from the outlet port 78d of the charge cell 78 to the inlet port 23d of the storage unit 23. The pipe 80 hence causes the negative-electrode liquid 22 flowing out of the outlet port 78d to flow into the inlet port 23d.

The pipe 71, the pump 72, the pipe 73, and the pipe 79 form a mechanism that generates a flow of the positive-electrode liquid 21 where the positive-electrode liquid 21 flows into the inlet port 78a of the charge cell 78 and flows out of the outlet port 78c of the charge cell 78.

The pipe 74, the pump 75, the pipe 76, and the pipe 80 form a mechanism that generates a flow of the negative-electrode liquid 22 where the negative-electrode liquid 22 flows into the inlet port 78b of the charge cell 78 and flows out of the outlet port 78d of the charge cell 78.

The control circuit 81 controls the pump 72 and the pump 75. The control circuit 81 hence forms a control unit that changes the flow rate of a positive-electrode liquid 92 in a first flow path 91e in the charge cell 78 and/or the flow rate of a negative-electrode liquid 97 in a second flow path 96e in the charge cell 78.

The control circuit 81 controls the power supply 77. The control circuit 81 hence forms an electrical conduction control unit that changes the current value of an electric current flowing between a positive electrode 93 of the charge cell 78 and a negative electrode 98 of the charge cell 78.

The control circuit 81 includes a microcontroller and peripheral circuitry. The microcontroller includes a processor and a memory. The processor runs the programs stored in the memory to cause the microcontroller and the peripheral circuitry to operate as the control unit and the electrical conduction control unit. All or some of the processes executed by the microcontroller may be executed by a dedicated electronic circuit.

### 1.8 Charge Cell

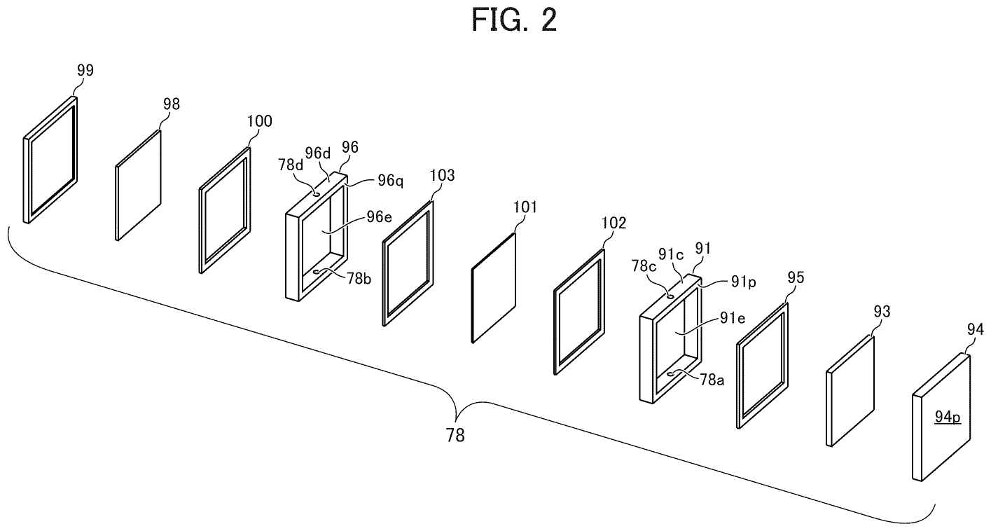

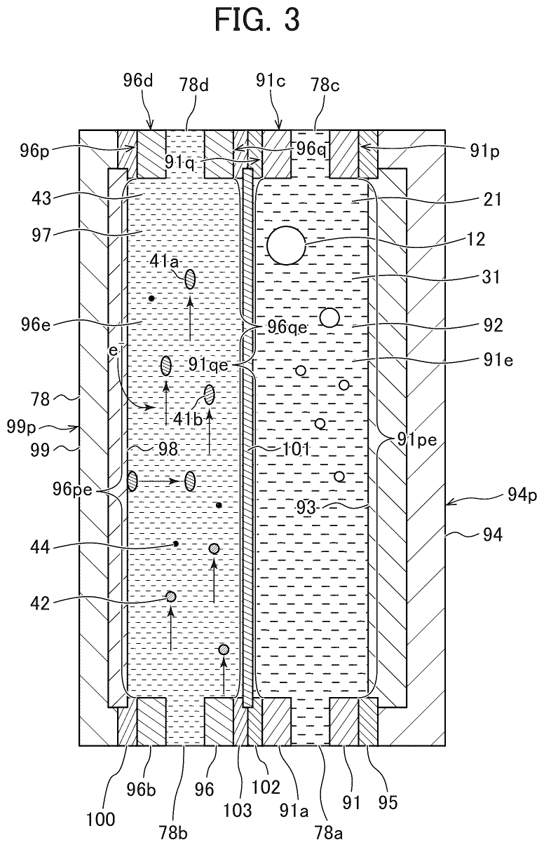

FIG. 2 is a schematic exploded perspective view of a charge cell included in the metal-air flow battery in accordance with Embodiment 1. FIG. 3 is a schematic cross-sectional view of the charge cell included in the metal-air flow battery in accordance with Embodiment 1.

Referring to FIGS. 2 and 3, the charge cell 78 includes a first layer 91, the positive-electrode liquid 92, the positive electrode 93, an electrical conduction plate 94, a gasket 95, a second layer 96, the negative-electrode liquid 97, the negative electrode 98, an electrical conduction plate 99, a gasket 100, a separator 101, a gasket 102, and a gasket 103.

The first layer 91 is shaped like a rectangular frame. Therefore, the first layer 91 has an opening face 91p, an opening face 91q, an end face 91a, and an end face 91c. The opening face 91p and the opening face 91q are positioned opposite each other. The end face 91a and the end face 91c are positioned opposite each other. The first layer 91 may be shaped like any frame other than a rectangular frame.

The first flow path 91e is formed in the first layer 91.

The first flow path 91e in the first layer 91 is open on the opening face 91p and the opening face 91q so as to have an opening 91pe and an opening 91qe on the opening face 91p and the opening face 91q respectively.

The first flow path 91e is open on the end face 91a and the end face 91c so as to have an inlet port 78a and the outlet port 78c on the end face 91a and the end face 91c respectively. The first flow path 91e therefore extends from the inlet port 78a to the outlet port 78c. The first flow path 91e hence passes the positive-electrode liquid 92 flowing into the inlet port 78a and allows the passing positive-electrode liquid 21 to flow out of the outlet port 78c.

The inlet port 78a and the outlet port 78c of the charge cell 78 are positioned toward the underside in terms of the vertical direction and toward the topside in terms of the vertical direction respectively. Therefore, the first flow path 91e in the first layer 91 includes a portion in which the positive-electrode liquid 92 is guided in the vertical direction. The inlet port 78a may be positioned in a location other than toward the underside in terms of the vertical direction, and the outlet port 78c may be positioned in a location other than toward the topside in terms of the vertical direction.

The positive-electrode liquid 92 flows in the first flow path 91e in the first layer 91. The positive-electrode liquid 92 is part of the positive-electrode liquid 21. As described above, the inlet port 78a and the outlet port 78c of the charge cell 78 are positioned toward the underside in terms of the vertical direction and toward the topside in terms of the vertical direction respectively. Therefore, the positive-electrode liquid 92, in the portion in which the positive-electrode liquid 92 is guided in the vertical direction, has a flow direction from the underside toward the topside in terms of the vertical direction.

When the flow direction of the positive-electrode liquid 92 is from the topside toward the underside in terms of the vertical direction, the positive-electrode liquid 92 flows and falls out of the first flow path 91e even before the first flow path 91e in the first layer 91 is completely filled with the positive-electrode liquid 92. Therefore, the first flow path 91e may in some cases not be completely filled with the positive-electrode liquid 92. On the other hand, when the flow direction of the positive-electrode liquid 92 is from the underside toward the topside in terms of the vertical direction, the positive-electrode liquid 92 overflows from the first flow path 91e after the first flow path 91e is completely filled with the positive-electrode liquid 92. Therefore, the first flow path 91e can be completely filled with the positive-electrode liquid 92.

The gaseous oxygen 12 produced on the positive electrode 93 not only moves due to buoyancy from the underside toward the topside in terms of the vertical direction, but also moves on the flow of the positive-electrode liquid 92 from the underside toward the topside in terms of the vertical direction. This specific arrangement facilitates ejecting the gaseous oxygen 12 from the charge cell 78.

The positive electrode 93 is shaped like a rectangular plate. The positive electrode 93 is disposed on the opening face 91p of the first layer 91. Hence, the positive electrode 93 occludes the opening 91pe of the first layer 91 so as to face the first flow path 91e in the first layer 91. The positive electrode 93 is thereby in contact with the positive-electrode liquid 92 flowing in the first flow path 91e. The oxidation reaction of water of chemical equation (5) therefore occurs on the positive electrode 93.

$$4 {OH}^{-} \to {O}_{2} + 2 {H}_{2} + 4 {e}^{-} \qquad ( 5 )$$

Therefore, the charge cell 78 produces the gaseous oxygen 12 in the oxidation reaction of water that occurs on the positive electrode 93. The produced gaseous oxygen 12 is ejected from the charge cell 78.

The positive electrode 93 is made of a material with a high oxygen-producing capability, which can increase the charge efficiency of the charge cell 78 and stabilize the charging operation of the charge cell 78. The material with a high oxygen-producing capability contains, for example, nickel.

The electrical conduction plate 94 is shaped like a rectangular plate. The electrical conduction plate 94 is disposed on the opening face 91p of the first layer 91, overlapping the positive electrode 93. Hence, the electrical conduction plate 94 is in contact with the positive electrode 93, forming an electrical conduction path that leads to the positive electrode 93.

The gasket 95 is sandwiched by the opening face 91p of the first layer 91 and a combination of the positive electrode 93 and the electrical conduction plate 94, thereby occluding the space between the opening face 91p of the first layer 91 and a combination of the positive electrode 93 and the electrical conduction plate 94 in a liquid-tight manner.

The second layer 96 is shaped like a rectangular frame. Therefore, the second layer 96 has an opening face 96p, an opening face 96q, an end face 96b, and an end face 96d. The opening face 96p and the opening face 96q are positioned opposite each other. The end face 96b and the end face 96d are positioned opposite each other.

The second flow path 96e is formed in the second layer 96.

The second flow path 96e in the second layer 96 is open on the opening face 96p and the opening face 96q so as to have an opening 96pe and an opening 96qe on the opening face 96p and the opening face 96q respectively.

The second flow path 96e is open to the end face 96b and the end face 96d so as to have the inlet port 78b and the outlet port 78d on the end face 96b and the end face 96d respectively. The second flow path 96e therefore extends from the inlet port 78b to the outlet port 78d. The second flow path 96e hence passes the negative-electrode liquid 97 flowing into the inlet port 78b and allows the passing negative-electrode liquid 97 to flow out of the outlet port 78d.

The inlet port 78b and the outlet port 78d of the charge cell 78 are disposed toward the underside in terms of the vertical direction and toward the topside in terms of the vertical direction respectively. Therefore, the second flow path 96e in the second layer 96 includes a portion in which the negative-electrode liquid 97 is guided in the vertical direction.

The negative-electrode liquid 97 flows in the second flow path 96e in the second layer 96. The negative-electrode liquid 97 is part of the negative-electrode liquid 22. As described above, the inlet port 78b and the outlet port 78d of the charge cell 78 are disposed toward the underside in terms of the vertical direction and toward the topside in terms of the vertical direction respectively. Therefore, the negative-electrode liquid 97, in the portion in which the negative-electrode liquid 97 is guided in the vertical direction, has a flow direction from the underside toward the topside in terms of the vertical direction.

When the flow direction of the negative-electrode liquid 97 is from the topside toward the underside in terms of the vertical direction, the negative-electrode liquid 97 flows and falls out of the second flow path 96e even before the second flow path 96e in the second layer 96 is completely filled with the negative-electrode liquid 97. Therefore, the second flow path 96e may in some cases not be completely filled with the negative-electrode liquid 97. On the other hand, when the flow direction of the negative-electrode liquid 97 is from the underside toward the topside in terms of the vertical direction, the negative-electrode liquid 97 overflows from the second flow path 96e after the second flow path 96e is completely filled with the negative-electrode liquid 97. Therefore, the second flow path 96e can be completely filled with the negative-electrode liquid 97.

The reduced negative-electrode active material particles 41a, produced on the negative electrode 98, has a greater specific gravity than does the negative-electrode liquid 97. Therefore, when the flow direction of the negative-electrode liquid 97 is from the topside toward the underside in terms of the vertical direction, the reduced negative-electrode active material particles 41a move from the topside toward the underside in terms of the vertical direction and precipitate. However, when the flow direction of the negative-electrode liquid 97 is from the underside toward the topside in terms of the vertical direction, the reduced negative-electrode active material particles 41a move on the flow of the positive-electrode liquid 92 against gravity from the underside toward the topside in terms of the vertical direction. This specific arrangement enables ejecting the reduced negative-electrode active material particles 41a from the charge cell 78 after the reduced negative-electrode active material particles 41a have grown to a such a particle diameter as to be sufficiently affected by the drag force exerted by the negative-electrode liquid 97.

The negative electrode 98 is shaped like a rectangular plate. The negative electrode 98 is disposed on the opening face 96p of the second layer 96. Hence, the negative electrode 98 occludes the opening 96pe of the second layer 96 so as to face the second flow path 96e in the second layer 96. The negative electrode 98 is thereby in contact with the negative-electrode liquid 97 flowing in the second flow path 96e. Therefore, on the negative electrode 98, a negative-electrode liquid containing the zincate ions Zn(OH)₄²⁻ and/or the zinc oxide ZnO produced in the oxidation reaction of metal zinc of chemical equations (2) and (3) is fed to the negative electrode 98. The reduction reaction to metal zinc of chemical equations (6) and (7) hence occurs on the negative electrode 98.

$$ZnO + {H}_{2} O + 2 {OH}^{-} \to Zn {( OH )}_{{4}^{2 -}} \qquad ( 6 )$$

$$Zn {( OH )}_{{4}^{2 -}} + 2 {e}^{-} \to Zn + 4 {OH}^{-} \qquad ( 7 )$$

Therefore, the charge cell 78 causes the reduced negative-electrode active material particles 41a to be produced in the reduction reaction to metal zinc on the negative electrode 98. The produced reduced negative-electrode active material particles 41a adhere to the negative electrode 98.

The negative electrode 98 is made of a material capable of restraining hydrogen-producing reaction that competes against the reduction reaction to metal zinc. The material capable of restraining the hydrogen-producing reaction includes, for example, at least one species selected from the group consisting of carbon, copper, and magnesium. Carbon includes, for example, graphite. Carbon is resistant to corrosion. Therefore, when the negative electrode 98 is made of carbon, the charge efficiency of the charge cell 78 is restrained from decreasing due to the corrosion of the negative electrode 98. This in turn increases the long-term stability of the charge cell 78. In addition, the reduced negative-electrode active material particles 41a exhibit low adhesion to magnesium. Therefore, if the negative electrode 98 is made of magnesium, it facilitates detaching the reduced negative-electrode active material particles 41a from the negative electrode 98 to transport the reduced negative-electrode active material particles 41a out of the charge cell 78.

The electrical conduction plate 99 is shaped like a rectangular plate. The electrical conduction plate 99 is disposed on the opening face 96p of the second layer 96, overlapping the negative electrode 98. Hence, the electrical conduction plate 99 is in contact with the negative electrode 98, forming an electrical conduction path that leads to the negative electrode 98.

The gasket 100 is sandwiched by the opening face 96p of the second layer 96 and a combination of the negative electrode 98 and the electrical conduction plate 99, thereby occluding the space between the opening face 96p of the second layer 96 and a combination of the negative electrode 98 and the electrical conduction plate 99 in a liquid-tight manner.

The separator 101 is shaped like a sheet. The separator 101 is flexible. The separator 101 is disposed on the opening face 91q of the first layer 91. The separator 101 hence occludes the opening 91qe of the first layer 91 and faces the first flow path 91e in the first layer 91. In addition, the separator 101 is disposed on the opening face 96q of the second layer 96. The separator 101 hence occludes the opening 96qe of the second layer 96 and faces the second flow path 96e in the second layer 96.

The separator 101 is sandwiched by the first layer 91 and the second layer 96. The separator 101 hence separates the first flow path 91e in the first layer 91 and the second flow path 96e in the second layer 96 from each other. The separator 101 does not pass the reduced negative-electrode active material particles 41a, the oxidized negative-electrode active material particles 41b, and a thickening agent 44. Hence, the separator 101 restrains the reduced negative-electrode active material particles 41a, the oxidized negative-electrode active material particles 41b, and the thickening agent 44 from moving from the negative-electrode liquid 97 to the positive-electrode liquid 92.

The separator 101 has high ionic conduction. The separator 101 hence passes hydroxide ions OH⁻. This specific arrangement enables hydroxide ions OH⁻ to move from the negative-electrode liquid 97 to the positive-electrode liquid 92.

Because of the requirement to prevent the transmission of the reduced negative-electrode active material particles 41a, the oxidized negative-electrode active material particles 41b, and the thickening agent 44, the separator 101 is a film preferably with no fine pores greater than or equal to 50 nm and more preferably with no fine pores greater than or equal to 100 nm. The separator 101 is, for example, an anionic exchange film, a hydrous gel film, or a film of a plurality of inorganic ionic conductor particles and a resin with which the grain boundaries of these plurality of inorganic ionic conductor particles are impregnated.

In the reduction reaction of the negative electrode 98 to metal zinc, in other words, the electrodeposition reaction of metal zinc, metal zinc could grow in tree-like form, in other words, in dendritic form from the negative electrode 98 due to non-uniform electric current distribution. The separator 101 has high resistance to dendrite growth. The separator 101 therefore hinders dendritic metal zinc to grow beyond the separator 101. Hence, the positive electrode 93 and the negative electrode 98 can be restrained from being short-circuited via dendritic metal zinc.

The gasket 102 is sandwiched by the opening face 91q of the first layer 91 and the separator 101, thereby occluding the space between the opening face 91q of the first layer 91 and the separator 101 in a liquid-tight manner.

The gasket 103 is sandwiched by the opening face 96q of the second layer 96 and the separator 101, thereby occluding the space between the opening face 96q of the second layer 96 and the separator 101 in a liquid-tight manner.

### 1.9 Theoretical Voltage of Metal-Air Flow Battery

The total reaction of chemical equation (8) occurs in the charge cell 78 owing to the oxidation reaction of water on the positive electrode 93 and the reduction reaction to metal zinc on the negative electrode 98.

$$2 Zn + {O}_{2} \to 2 ZnO \qquad ( 8 )$$

Therefore, the charge cell 78, upon being charged, changes zinc oxide to metal zinc.

The electrical potentials of the positive and negative electrodes while discharge reaction and charge reaction are occurring are −1.25 V and 0.40 V respectively relative to standard hydrogen electrode. Therefore, the theoretical voltage of the metal-air flow battery 1 is 1.65 V.

### 1.10 Viscosities of Positive-Electrode Liquid and Negative-Electrode Liquid

The positive-electrode liquid 92 has a first viscosity. The negative-electrode liquid 97 has a second viscosity that is higher than the first viscosity. The first viscosity is, for example, from 1 mPasec to 9 mPasec, both inclusive, and preferably from 2 mPasec to 3 mPasec, both inclusive. The second viscosity is, for example, from 100 mPasec to 2,000 mPasec, both inclusive, and preferably from 200 mPasec to 500 mPasec, both inclusive. The viscosity of the positive-electrode liquid 92 can be measured using, for example, a Ubbelohde viscometer, and the viscosity of the negative-electrode liquid 97 can be measured using, for example, a VT-06 manufactured by Rion Co., Ltd.

When the positive-electrode liquid 92 has a high viscosity, the gaseous oxygen 12 produced on the positive electrode 93 is likely to be fetched by the positive-electrode liquid 92, and the positive-electrode liquid 92 turns into a bubbling state. Therefore, it becomes more difficult to separate out the gaseous oxygen 12 from the positive-electrode liquid 92 and to eject the separated gaseous oxygen 12 from the charge cell 78. The charge efficiency of the charge cell 78 is therefore reduced.

In contrast, when the positive-electrode liquid 92 has a low viscosity, a turbulent flow in the positive-electrode liquid 92 facilitates the growth of bubbles of the gaseous oxygen 12. Therefore, it becomes easier to separate out the gaseous oxygen 12 from the positive-electrode liquid 92 and to eject the separated gaseous oxygen 12 from the charge cell 78. Therefore, the charge efficiency of the charge cell 78 is increased.

When the negative-electrode liquid 97 has a low viscosity, the drag force exerted on the reduced negative-electrode active material particles 41a when the negative-electrode liquid 97 acts on the reduced negative-electrode active material particles 41a decreases. Therefore, it becomes more difficult to detach the reduced negative-electrode active material particles 41a from the negative electrode 98 and to eject the detached reduced negative-electrode active material particles 41a from the charge cell 78. In addition, it becomes more difficult to prevent the reduced negative-electrode active material particles 41a from precipitating under gravity.

On the other hand, when the negative-electrode liquid 97 has a high viscosity, the drag force exerted on the reduced negative-electrode active material particles 41a when the negative-electrode liquid 97 acts on the reduced negative-electrode active material particles 41a increases. Therefore, it becomes easier to detach the reduced negative-electrode active material particles 41a from the negative electrode 98 and to eject the detached reduced negative-electrode active material particles 41a from the charge cell 78. In addition, it becomes easier to prevent the reduced negative-electrode active material particles 41a from precipitating under gravity.

When the detachment of the reduced negative-electrode active material particles 41a from the negative electrode 98 is facilitated by controlling the second viscosity to a value higher than the first viscosity as described here, there is no longer a need to provide a movable unit that detaches the reduced negative-electrode active material particles 41a from the negative electrode 98. Hence, the metal-air flow battery 1 can be provided that allows the reduced negative-electrode active material particles 41a to be detached from the negative electrode 98 without having to consume large electric power and that has high durability.

The viscosity of the negative-electrode liquid 97 is adjusted by means of the type and/or concentration of the thickening agent 44 contained in the negative-electrode liquid 97. The thickening agent 44 is, for example, an organic polymer material or inorganic material particles with a particle diameter of less than 1 μm. The organic polymer material is, for example, polyacrylic acid, carboxy methyl cellulose, sodium alginate, or an acrylic acid-methacrylic acid alkyl copolymer. The inorganic material is, for example, calcium hydroxide or potassium silicate. The adjustment of the viscosity of the negative-electrode liquid 97 may be done by means of the concentration of the oxidized negative-electrode active material particles 41b with a particle diameter of less than 1 μm. When the adjustment of the viscosity of the negative-electrode liquid 97 is done by means of the concentration of the oxidized negative-electrode active material particles 41b, the negative-electrode liquid 97 may not contain the thickening agent 44. When the negative-electrode active material ions 42 are zincate ions (Zn(OH)₄²⁻), the concentration of the negative-electrode active material ions 42 in the negative-electrode liquid 97 can be controlled to be suitable to charge reaction by using calcium hydroxide or potassium silicate as the thickening agent 44 because calcium hydroxide or potassium silicate affects the solubility of zincate ions (Zn(OH)₄²⁻).

When the negative-electrode liquid 97 contains the thickening agent 44, the separator 101 does not transmit the thickening agent 44. Hence, the separator 101 restrains the thickening agent 44 from moving from the negative-electrode liquid 97 to the positive-electrode liquid 92. Hence, a condition where the viscosity of the negative-electrode liquid 97 is higher than the viscosity of the positive-electrode liquid 92 can be maintained for an extended period of time. Hence, it becomes easier to separate out the gaseous oxygen 12 from the positive-electrode liquid 92 and eject the separated gaseous oxygen 12 from the charge cell 78 than in conventional cases, enabling maintaining, for an extended period of time, the condition where it is easy to detach the reduced negative-electrode active material particles 41a from the negative electrode 98 and to eject the detached reduced negative-electrode active material particles 41a from the charge cell 78. Hence, a condition where the charge efficiency of the charge cell 78 is high can be maintained for an extended period of time.

### 1.11 Additional Components of Negative-electrode Liquid

The negative-electrode liquid 97 preferably contains at least one species of ions selected from the group consisting of Group 13 metal elements, Group 14 metal elements, and Group 15 metal elements, more preferably contains at least one species of ions selected from the group consisting of indium and thallium, which are Group 13 metal elements, tin and lead, which are Group 14 metal elements, and antimony and bismuth, which are Group 15 metal elements, and particularly preferably contains indium ions. When the negative-electrode liquid 22 contains these ions, the adherence of the reduced negative-electrode active material particles 41a to the negative electrode 98 can be reduced. Therefore, it becomes even easier to detach the reduced negative-electrode active material particles 41a from the negative electrode 98 and to eject the detached reduced negative-electrode active material particles 41a from the charge cell 78. When the negative-electrode liquid 97 contains these metal ions, the metal ions have a concentration of preferably from 20 to 300 ppm and more preferably from 50 to 200 ppm. If the concentration of these metal ions is less than 20 ppm, the adherence of the reduced negative-electrode active material particles 41a to the negative electrode 98 may not be sufficiently reduced. If the concentration of these metal ions exceeds 300 ppm, these metals may not be dissolved as ions, possibly depositing in the solution. In particular, when the negative-electrode liquid 22 contains indium ions, the adherence of the reduced negative-electrode active material particles 41a to the negative electrode 98 is reduced probably because indium has a lower ionization tendency than zinc, indium is produced from these indium ions before zinc is produced from zinc ions, and an underlayer is formed of the produced indium. It is therefore not suitable to contain ions of gallium, germanium, or arsenic, which have a higher ionization tendency than zinc, in the negative-electrode liquid 22.

### 1.12 First Control Example for Current Value and Flow Rate

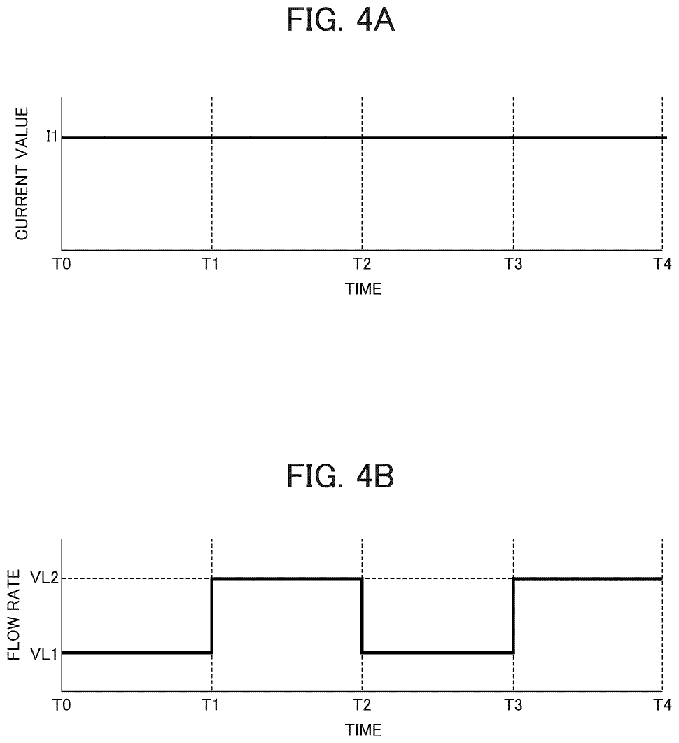

FIG. 4A is a graph representing a first control example for the current value of an electric current flowing between a positive and a negative electrode of the charge cell included in the metal-air flow battery in accordance with Embodiment 1. FIG. 4B is a graph representing a first control example for the flow rate of a negative-electrode liquid in a second flow path in a second layer in the charge cell included in the metal-air flow battery in accordance with Embodiment 1.

FIG. 4A shows time on the horizontal axis and the current value on the vertical axis. FIG. 4B shows time on the horizontal axis and the flow rate on the vertical axis.

In the first control example for the current value of an electric current flowing between the positive electrode 93 and the negative electrode 98 and for the flow rate of the negative-electrode liquid 97 in the second flow path 96e in the second layer 96, the control circuit 81, which is an electrical conduction control unit, maintains this current value at a constant current value I1 as shown in FIG. 4A. Therefore, this electrical conduction control unit controls the current value to the constant current value I1 in a period T0 to T4.

In addition, referring to FIG. 4B, the control circuit 81, which is a control unit, cyclically changes the flow rate between a first flow rate VL1 and a second flow rate VL2 that is higher than the first flow rate VL1. Therefore, the control unit controls the flow rate to the first flow rate VL1 in a period T0 to T1, the flow rate to the second flow rate VL2 in a period T1 to T2, the flow rate to the first flow rate VL1 in a period T2 to T3, and the flow rate to the second flow rate VL2 in a period T3 to T4.

The drag force exerted on the reduced negative-electrode active material particles 41a when the negative-electrode liquid 97 acts on the reduced negative-electrode active material particles 41a increases with an increase in the particle diameter of the reduced negative-electrode active material particles 41a and increases with an increase in the flow rate of the negative-electrode liquid 97. Therefore, it is preferable to instantaneously exert a large drag force exerted on the reduced negative-electrode active material particles 41a by increasing the flow rate of the negative-electrode liquid 97 at a timing when the reduced negative-electrode active material particles 41a have grown to a large particle diameter, in order to detach the reduced negative-electrode active material particles 41a from the negative electrode 98 and to eject the detached reduced negative-electrode active material particles 41a from the charge cell 78.

When the current value and the flow rate are controlled as shown in FIGS. 4A and 4B respectively, the battery is charged, but the drag force exerted on the reduced negative-electrode active material particles 41a decreases in the period T0 to T1 and the period T2 to T3 in which the flow rate is reduced to the first flow rate VL1 to charge the battery, thereby allowing the growth of the reduced negative-electrode active material particles 41a. Therefore, the particle diameter of the reduced negative-electrode active material particles 41a increases.

Then, in the period T1 to T2 and the period T3 to T4 in which the flow rate is increased to the second flow rate VL2, the drag force exerted on the reduced negative-electrode active material particles 41a, now having an increased particle diameter, increases.

For these reasons, it becomes possible to facilitate detaching the reduced negative-electrode active material particles 41a from the negative electrode 98 and ejecting the detached reduced negative-electrode active material particles 41a from the charge cell 78. In addition, by controlling the flow rate to the first flow rate VL1 in the period T0 to T1 and the period T2 to T3, the electric power consumed to produce a flow of the negative-electrode liquid 97 can be reduced.

When the detaching of the reduced negative-electrode active material particles 41a from the negative electrode 98 is facilitated by controlling the current value and the flow rate as described here, there is no longer a need to provide a movable unit that detaches the reduced negative-electrode active material particles 41a from the negative electrode 98. Hence, the metal-air flow battery 1 can be provided that allows the reduced negative-electrode active material particles 41a to be detached from the negative electrode 98 without having to consume large electric power and that has high durability.

Here, although FIG. 4A shows a control method by which the current value is maintained at the constant current value I1 in the period T0 to T4, a control method may be employed by which the current value is varied under a condition exceeding a prescribed current value in the period T0 to T4. In addition, although FIG. 4B shows a control method by which the flow rate is maintained at VL1 in the period T0 to T1 and the period T2 to T3, and the flow rate is maintained at VL2 in the period T1 to T2 and the period T3 to T4, a control method may be employed by which the flow rate is controlled to a value larger than or equal to VL1 in the period T0 to T1 and the period T2 to T3, and the flow rate is controlled to a value smaller than or equal to VL2 in the period T1 to T2 and the period T3 to T4.

In addition, although FIG. 4B shows a control method by which the period T0 to T1, the period T1 to T2, the period T2 to T3, and the period T3 to T4 have the same length, the period T1 to T2 and the period T3 to T4 are preferably shorter than the period T0 to T1 and the period T2 to T3 and are more preferably ⅕ to 1/20 times as long as the period T0 to T1 and the period T2 to T3, with a view to reduce the electric power consumed to produce a flow of the negative-electrode liquid 97.

### 1.13 Second Control Example for Current Value and Flow Rate

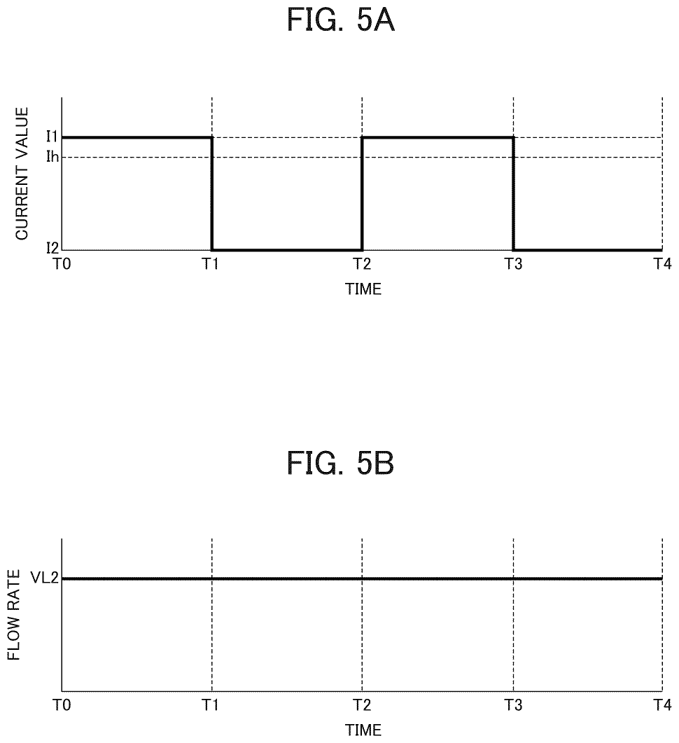

FIG. 5A is a graph representing a second control example for the current value of an electric current flowing between a positive and a negative electrode of the charge cell included in the metal-air flow battery in accordance with Embodiment 1. FIG. 5B is a graph representing a second control example for the flow rate of a negative-electrode liquid in the second flow path in the charge cell included in the metal-air flow battery in accordance with Embodiment 1.

FIG. 5A shows time on the horizontal axis and the current value on the vertical axis. FIG. 5B shows time on the horizontal axis and the flow rate on the vertical axis.

In the second control example for the current value of an electric current flowing between the positive electrode 93 and the negative electrode 98 and for the flow rate of the negative-electrode liquid 97 in the second flow path 96e in the second layer 96, the control circuit 81, which is an electrical conduction control unit, cyclically changes the current value between a first current value I1 and a second current value I2 that is smaller than the first current value I1 as shown in FIG. 5A. Therefore, this electrical conduction control unit controls the current value to the first current value I1 in the period T0 to T1, the current value to the second current value I2 in the period T1 to T2, the current value to the first current value I1 in the period T2 to T3, and the current value to the second current value I2 in the period T3 to T4. The electrical conduction control unit preferably controls the second current value I2 to a value smaller than the first current value I1 and more preferably controls the second current value I2 to 0 and alternately causes an electric current to flow between the positive electrode 93 and the negative electrode 98 and to either lower or stop the electric current flow between the positive electrode 93 and the negative electrode 98.

In addition, referring to FIG. 5B, the control circuit 81, which is a control unit, maintains the flow rate at a constant flow rate VL2. Therefore, this control unit controls the flow rate to a constant flow rate VL2 in the period T0 to T4.

The drag force exerted on the reduced negative-electrode active material particles 41a when the negative-electrode liquid 97 acts on the reduced negative-electrode active material particles 41a increases with an increase in the particle diameter of the reduced negative-electrode active material particles 41a. Therefore, the particle diameter of the reduced negative-electrode active material particles 41a is preferably increased to detach the reduced negative-electrode active material particles 41a from the negative electrode 98 and to eject the detached reduced negative-electrode active material particles 41a from the charge cell 78. It should be understood however that the growth of the reduced negative-electrode active material particles 41a is preferably stopped while the reduced negative-electrode active material particles 41a are being detached from the negative electrode 98.

When the current value and the flow rate are controlled as shown in FIGS. 5A and 5B respectively, the reduced negative-electrode active material particles 41a grow in the period T0 to T1 and the period T2 to T3 in which the battery is charged with the first current value I1. Therefore, the particle diameter of the reduced negative-electrode active material particles 41a increases.

Then, in the period T1 to T2 and the period T3 to T4 in which the battery is charged with the second current value I2, the large drag force exerted on the reduced negative-electrode active material particles 41a, now having an increased particle diameter, detaches the reduced negative-electrode active material particles 41a from the negative electrode 98. The growth of the reduced negative-electrode active material particles 41a is either restrained or stopped in the period T1 to T2 and the period T3 to T4.

For these reasons, it becomes possible to facilitate detaching the reduced negative-electrode active material particles 41a from the negative electrode 98 and ejecting the detached reduced negative-electrode active material particles 41a from the charge cell 78.

The first current value I1 may be controlled to a value larger than a current value Ih at which a hydrogen-producing reaction that competes against the reduction reaction by which the reduced negative-electrode active material particles 41a are produced on the negative electrode 98, starts. Therefore, the first current value I1 may be controlled to a current value that is larger than the current value Ih and at which hydrogen gas is produced on the negative electrode 98. The produced hydrogen gas increases the internal pressure of the interior the second flow path 96e in the second layer 96 and increases the flow rate of the negative-electrode liquid 97 in the second flow path 96e. Therefore, when hydrogen gas is produced on the negative electrode 98, the drag force exerted on the reduced negative-electrode active material particles 41a when the negative-electrode liquid 97 acts on the reduced negative-electrode active material particles 41a increases. Hence, it becomes possible to facilitate detaching the reduced negative-electrode active material particles 41a from the negative electrode 98 and ejecting the detached reduced negative-electrode active material particles 41a from the charge cell 78. In addition, the produced hydrogen gas adheres to the reduced negative-electrode active material particles 41a and exerts buoyancy on the reduced negative-electrode active material particles 41a. Hence, it becomes possible to facilitate detaching the reduced negative-electrode active material particles 41a from the negative electrode 98 and ejecting the detached reduced negative-electrode active material particles 41a from the charge cell 78. In addition, the produced hydrogen gas adheres to the reduced negative-electrode active material particles 41a so as to increase the apparent

Stokes diameter of the reduced negative-electrode active material particles 41a. Therefore, when hydrogen gas is produced on the negative electrode 98, the drag force exerted on the reduced negative-electrode active material particles 41a when the negative-electrode liquid 97 acts on the reduced negative-electrode active material particles 41a increases. Hence, it becomes possible to facilitate detaching the reduced negative-electrode active material particles 41a from the negative electrode 98 and ejecting the detached reduced negative-electrode active material particles 41a from the charge cell 78.

When the detaching of the reduced negative-electrode active material particles 41a from the negative electrode 98 is facilitated by controlling the current value and the flow rate as described here, there is no longer a need to provide a movable unit that detaches the reduced negative-electrode active material particles 41a from the negative electrode 98. Hence, the metal-air flow battery 1 can be provided that allows the reduced negative-electrode active material particles 41a to be detached from the negative electrode 98 without having to consume large electric power and that has high durability.

Here, although FIG. 5A shows a control method by which the current value is maintained at I1 in the period T0 to T1 and the period T2 to T3 and the current value is maintained at 12 in the period T1 to T2 and the period T3 to T4, a control method may be employed by which the current value is controlled to a value greater than or equal to I1 in the period T0 to T1 and the period T2 to T3, and the current value is controlled to a value less than or equal to I2 in the period T1 to T2 and the period T3 to T4. In addition, although FIG. 5B shows a control method by which the flow rate is maintained at constant VL2 in the period T0 to T4, a control method may be employed by which the flow rate is varied under a condition exceeding a prescribed flow rate in the period T0 to T4.

In addition, although FIG. 5A shows a control method by which the period T0 to T1, the period T1 to T2, the period T2 to T3, and the period T3 to T4 have the same length, the period T1 to T2 and the period T3 to T4 are preferably shorter than the period T0 to T1 and the period T2 to T3 and are more preferably ⅕ to 1/20 times as long as the period T0 to T1 and the period T2 to T3, with a view to streamline the charge reaction.

### 1.14 Third Control Example for Current Value and Flow Rate

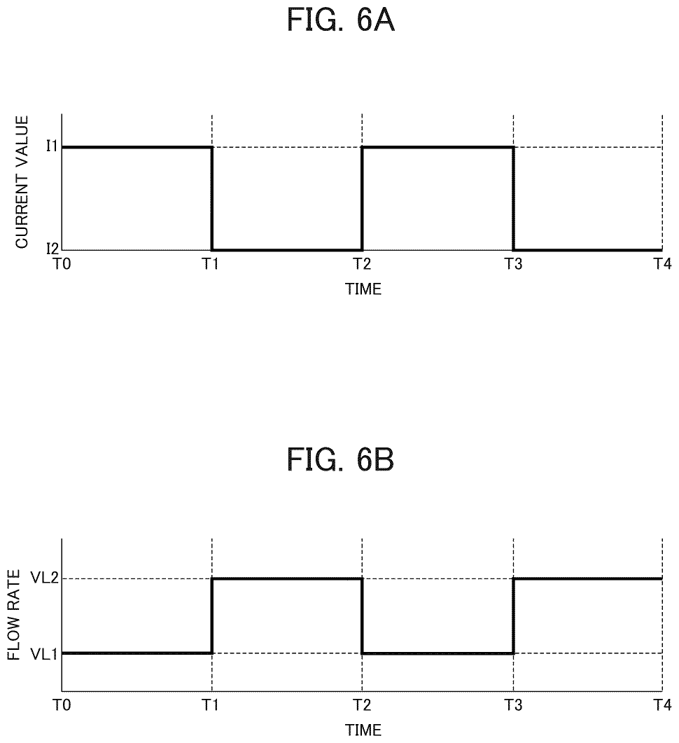

FIG. 6A is a graph representing a third control example for the current value of an electric current flowing between a positive and a negative electrode of the charge cell included in the metal-air flow battery in accordance with Embodiment 1. FIG. 6B is a graph representing a third control example for the flow rate of a negative-electrode liquid in the second flow path in the charge cell included in the metal-air flow battery in accordance with Embodiment 1.

FIG. 6A shows time on the horizontal axis and the current value on the vertical axis. FIG. 6B shows time on the horizontal axis and the flow rate on the vertical axis.

In the third control example for the current value of an electric current flowing between the positive electrode 93 and the negative electrode 98 and for the flow rate of the negative-electrode liquid 97 in the second flow path 96e in the second layer 96, the control circuit 81, which is an electrical conduction control unit, cyclically changes the current value between a first current value I1 and a second current value I2 that is smaller than the first current value I1 as shown in FIG. 6A. Therefore, this electrical conduction control unit controls the current value to the first current value I1 in the period T0 to T1, the current value to the second current value I2 in the period T1 to T2, the current value to the first current value I1 in the period T2 to T3, and the current value to the second current value I2 in the period T3 to T4. The electrical conduction control unit preferably controls the second current value I2 to a value smaller than the first current value I1 and more preferably controls the second current value I2 to 0 and alternately causes an electric current to flow between the positive electrode 93 and the negative electrode 98 and to either lower or stop the electric current flow between the positive electrode 93 and the negative electrode 98.

In addition, referring to FIG. 6B, the control circuit 81, which is a control unit, cyclically changes the flow rate between a first flow rate VL1 and a second flow rate VL2 that is higher than the first flow rate VL1. Therefore, the control unit controls the flow rate to the first flow rate VL1 in the period T0 to T1, the flow rate to the second flow rate VL2 in the period T1 to T2, the flow rate to the first flow rate VL1 in the period T2 to T3, and the flow rate to the second flow rate VL2 in the period T3 to T4.

The drag force exerted on the reduced negative-electrode active material particles 41a when the negative-electrode liquid 97 acts on the reduced negative-electrode active material particles 41a increases with an increase in the particle diameter of the reduced negative-electrode active material particles 41a and increases with an increase in the flow rate of the negative-electrode liquid 97. Therefore, it is preferable to instantaneously exert a large drag force exerted on the reduced negative-electrode active material particles 41a by increasing the flow rate of the negative-electrode liquid 97 at a timing when the reduced negative-electrode active material particles 41a have grown to a large particle diameter, in order to detach the reduced negative-electrode active material particles 41a from the negative electrode 98 and to eject the detached reduced negative-electrode active material particles 41a from the charge cell 78. It should be understood however that the growth of the reduced negative-electrode active material particles 41a is preferably stopped while the reduced negative-electrode active material particles 41a are being detached from the negative electrode 98. Therefore, the period T0 to T1 and the period T2 to T3 in which the battery is charged with the first current value I1 include the period T0 to T1 and the period T2 to T3 in which the flow rate is controlled to the first flow rate VL1. In addition, the period T1 to T2 and the period T3 to T4 in which the battery is charged with the second current value I2 includes the periods T1 to T2 and T3 to T4 in which the flow rate is controlled to the second flow rate VL2.

When the current value and the flow rate are controlled as shown in FIGS. 6A and 6B respectively, the battery is charged with the first current value I1, but the drag force exerted on the reduced negative-electrode active material particles 41a decreases in the period T0 to T1 and the period T2 to T3 in which the flow rate is reduced to the first flow rate VL1, thereby allowing the growth of the reduced negative-electrode active material particles 41a. Therefore, the particle diameter of the reduced negative-electrode active material particles 41a increases.

Then, in the period T1 to T2 and the period T3 to T4 in which the flow rate is increased to the second flow rate VL2, the drag force exerted on the reduced negative-electrode active material particles 41a, now having an increased particle diameter, increases. The growth of the reduced negative-electrode active material particles 41a is restrained or stopped in the period T1 to T2 and the period T3 to T4.

For these reasons, it becomes possible to facilitate detaching the reduced negative-electrode active material particles 41a from the negative electrode 98 and ejecting the detached reduced negative-electrode active material particles 41a from the charge cell 78. In addition, by controlling the flow rate to the first flow rate VL1 in the period T1 to T2 and the period T2 to T3, the electric power consumed to produce a flow of the negative-electrode liquid 97 can be reduced.

When the detaching of the reduced negative-electrode active material particles 41a from the negative electrode 98 is facilitated by controlling the current value and the flow rate as described here, there is no longer a need to provide a movable unit that detaches the reduced negative-electrode active material particles 41a from the negative electrode 98. Hence, the metal-air flow battery 1 can be provided that allows the reduced negative-electrode active material particles 41a to be detached from the negative electrode 98 without having to consume large electric power and that has high durability.

Here, although FIG. 6A shows a control method by which the current value is maintained at I1 in the period T0 to T1 and the period T2 to T3 and the current value is maintained at I2 in the period T1 to T2 and the period T3 to T4, a control method may be employed by which the current value is controlled to a value greater than or equal to I1 in the period T0 to T1 and the period T2 to T3, and the current value is controlled to a value less than or equal to I2 in the period T1 to T2 and the period T3 to T4. In addition, although FIG. 6B shows a control method by which the flow rate is maintained at VL1 in the period T0 to T1 and the period T2 to T3 and the flow rate is maintained at VL2 in the period T1 to T2 and the period T3 to T4, a control method may be employed by which the flow rate is controlled to a value larger than or equal to VL1 in the period T0 to T1 and the period T2 to T3, and the flow rate is controlled to a value smaller than or equal to VL2 in the period T1 to T2 and the period T3 to T4.

In addition, although FIGS. 6A and 6B show a control method by which the period T0 to T1, the period T1 to T2, the period T2 to T3, and the period T3 to T4 have the same length, the period T1 to T2 and the period T3 to T4 are preferably shorter than the period T0 to T1 and the period T2 to T3 and more preferably ⅕ to 1/20 times as long as the period T0 to T1 and the period T2 to T3, with a view to reduce the electric power consumed to produce a flow of the negative-electrode liquid 97 and with a view to streamline the charge reaction.

### 1.15 Fourth Control Example for Current Value and Flow Rate

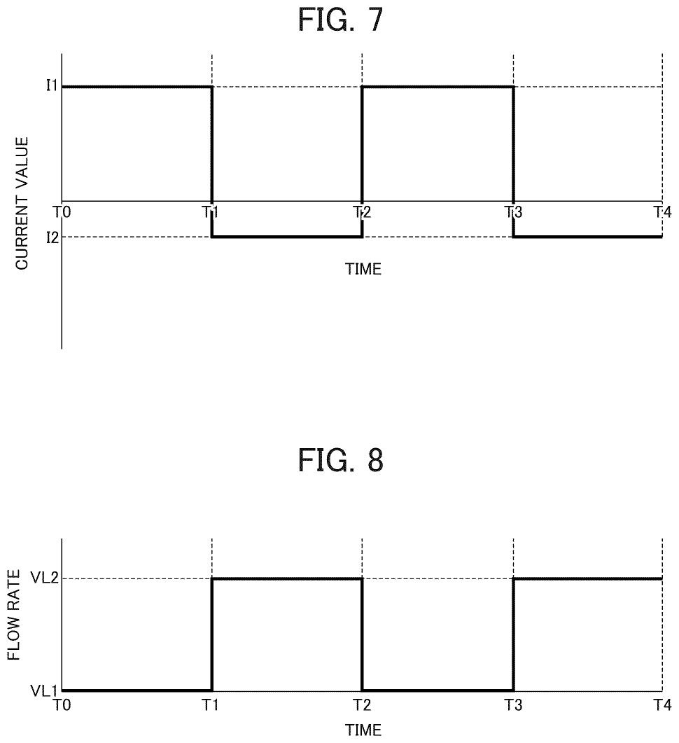

FIG. 7 is a graph representing a fourth control example for the current value of an electric current flowing between a positive and a negative electrode of the charge cell included in the metal-air flow battery in accordance with Embodiment 1.

FIG. 7 shows time on the horizontal axis and the current value on the vertical axis.

The following description will discuss differences between the fourth control example for the current value of an electric current flowing between the positive electrode 93 and the negative electrode 98 and for the flow rate of the negative-electrode liquid 97 in the second flow path 96e in the second layer 96 and the third control example for such an electric current and such a flow rate.

In the fourth control example for the electric current and the flow rate, similarly to the third control example for the electric current and the flow rate, the control circuit 81, which is an electrical conduction control unit, cyclically changes the current value between a first current value I1 and a second current value I2 that is smaller than the first current value I1 as shown in FIG. 7.

However, in the fourth control example for the electric current and the flow rate, unlike the third control example for the electric current and the flow rate, the first current value I1 and the second current value I2 have opposite signs as shown in FIG. 7. Therefore, the electric current flowing between the positive electrode 93 and the negative electrode 98 in the period T0 to T1 and the period T2 to T3 and the electric current flowing between the positive electrode 93 and the negative electrode 98 in the period T1 to T2 and the period T3 to T4 have opposite directions. The first current value I1 has a positive sign, and the second current value I2 has a negative sign. Therefore, reduction reaction to metal zinc occurs on the negative electrode 98 in the period T0 to T1 and the period T2 to T3, and oxidation reaction to zinc ions occurs on the negative electrode 98 in the period T1 to T2 and the period T3 to T4. The oxidation reaction to zinc ions occurs at the interface between the negative electrode 98 and the reduced negative-electrode active material particles 41a. Therefore, the reduced negative-electrode active material particles 41a are dissolved at the interface in the oxidation reaction to zinc ions. Hence, the adherence of the reduced negative-electrode active material particles 41a to the negative electrode 98 can be reduced. Hence, it becomes possible to facilitate detaching the reduced negative-electrode active material particles 41a from the negative electrode 98 and ejecting the detached reduced negative-electrode active material particles 41a from the charge cell 78.

When the detaching of the reduced negative-electrode active material particles 41a from the negative electrode 98 is facilitated by controlling the current value and the flow rate as described here, there is no longer a need to provide a movable unit that detaches the reduced negative-electrode active material particles 41a from the negative electrode 98. Hence, the metal-air flow battery 1 can be provided that allows the reduced negative-electrode active material particles 41a to be detached from the negative electrode 98 without having to consume large electric power and that has high durability.

### 1.16 Fifth Control Example for Current Value and Flow Rate

FIG. 8 is a graph representing a fifth control example for the flow rate of a negative-electrode liquid in the second flow path in the charge cell included in the metal-air flow battery in accordance with Embodiment 1.

FIG. 8 shows time on the horizontal axis and the flow rate on the vertical axis.

The following description will discuss differences between the fifth control example for the current value of an electric current flowing between the positive electrode 93 and the negative electrode 98 and for the flow rate of the negative-electrode liquid 97 in the second flow path 96e in the second layer 96 and the third control example for such an electric current and such a flow rate.

In the fifth control example, similarly to the third control example for the electric current and the flow rate, the control circuit 81, which is a control unit, cyclically changes the flow rate between a first flow rate VL1 and a second flow rate VL2 that is higher than the first flow rate VL1 as shown in FIG. 8.

However, in the fifth control example, unlike the third control example for the electric current and the flow rate, the first flow rate VL1 is equal to 0 as shown in FIG. 8. Hence, the electric power consume to produce a flow of the negative-electrode liquid 97 in the period T0 to T1 and the period T2 to T3 can be eliminated. In addition, the supply of the negative-electrode active material ions 42 onto the negative electrode 98 can be restricted in the period T0 to T1 and the period T2 to T3. Hence, the growth of the bulky, dendritic reduced negative-electrode active material particles 41a on the negative electrode 98 can be facilitated. Hence, the drag force exerted on the reduced negative-electrode active material particles 41a when the negative-electrode liquid 97 acts on the reduced negative-electrode active material particles 41a can be increased.

When the detaching of the reduced negative-electrode active material particles 41a from the negative electrode 98 is facilitated by controlling the current value and the flow rate as described here, there is no longer a need to provide a movable unit that detaches the reduced negative-electrode active material particles 41a from the negative electrode 98. Hence, the metal-air flow battery 1 can be provided that allows the reduced negative-electrode active material particles 41a to be detached from the negative electrode 98 without having to consume large electric power and that has high durability.

### 1.17 Variation Examples

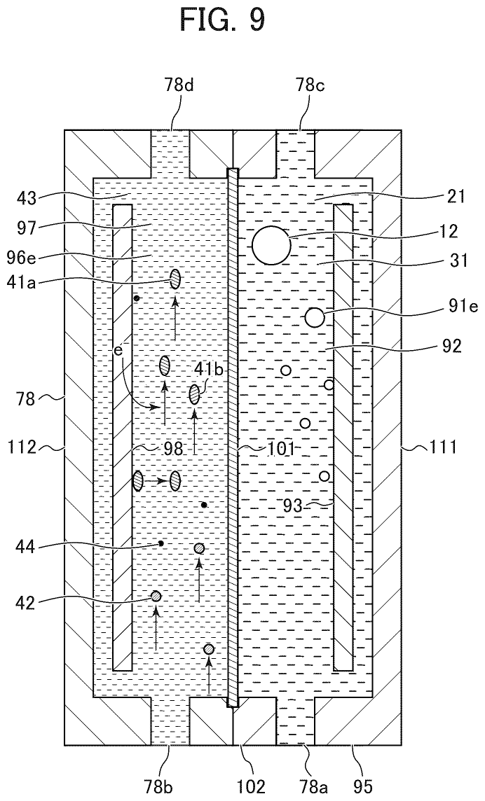

FIG. 9 is a schematic cross-sectional view of a charge cell included in a metal-air flow battery in accordance with a first variation example of Embodiment 1.

In Embodiment 1, referring to FIG. 3, a positive electrode chamber is formed of three positive-electrode-chamber-forming members that are the first layer 91, the electrical conduction plate 94, and the gasket 95, and a negative electrode chamber is formed of three negative-electrode-chamber-forming members that are the second layer 96, the electrical conduction plate 99, and the gasket 100.

In contrast, in the first variation example of Embodiment 1, referring to FIG. 9, a positive electrode chamber is formed of a single positive-electrode-chamber-forming member 111 that is an integration of the first layer 91, the electrical conduction plate 94, and the gasket 95, and a negative electrode chamber is formed of a single negative-electrode-chamber-forming member 112 that is an integration of the second layer 96, the electrical conduction plate 99, and the gasket 100.

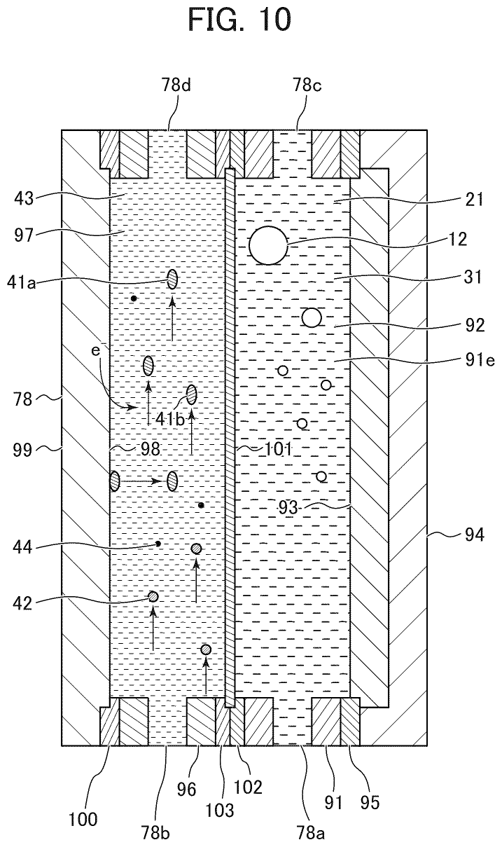

FIG. 10 is a schematic cross-sectional view of a charge cell included in a metal-air flow battery in accordance with a second variation example of Embodiment 1.

In Embodiment 1, referring to FIG. 3, the negative electrode 98 and the electrical conduction plate 99 are molded individually.

In contrast, in the second variation example of Embodiment 1, referring to FIG. 10, the electrical conduction plate 99 doubles as, and is integrated into, the negative electrode 98, and the negative electrode 98 and the electrical conduction plate 99 are molded as a single member. Hence, the number of components of the charge cell 78 can be reduced. In addition, the number of steps needed to assemble the charge cell 78 can be reduced. In addition, the lead time needed to assemble the charge cell 78 can be shortened. For these reasons, the cost of the charge cell 78 can be reduced.

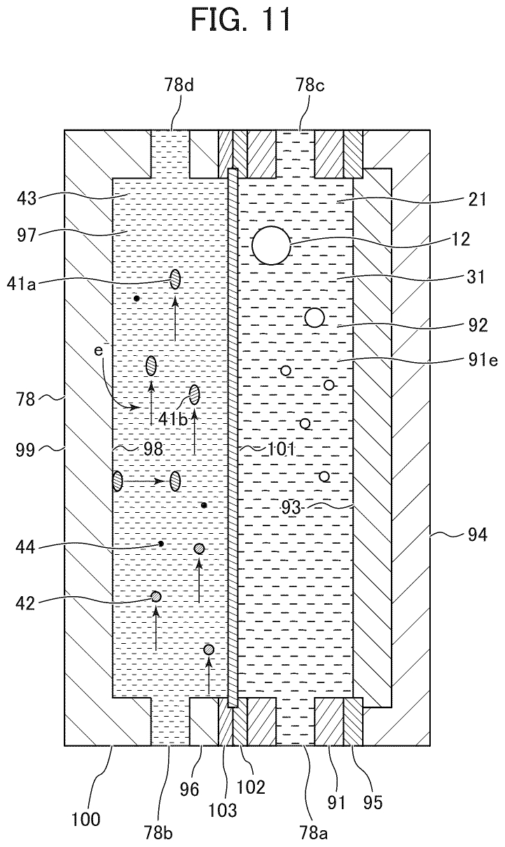

FIG. 11 is a schematic cross-sectional view of a charge cell included in a metal-air flow battery in accordance with a third variation example of Embodiment 1.

In Embodiment 1, referring to FIG. 3, the second layer 96, the negative electrode 98, and the electrical conduction plate 99 are molded individually.

In contrast, in the third variation example of Embodiment 1, referring to FIG. 11, the electrical conduction plate 99 doubles as, and is integrated into, the second layer 96 and the negative electrode 98, and the second layer 96, the negative electrode 98, and the electrical conduction plate 99 are molded as a single member. Hence, the number of components of the charge cell 78 can be reduced. In addition, the number of steps needed to assemble the charge cell 78 can be reduced. In addition, the lead time needed to assemble the charge cell 78 can be shortened. For these reasons, the cost of the charge cell 78 can be reduced. In addition, there is no longer a need to provide the gasket 100 that occludes the space between the second layer 96 and the negative electrode 98 and the space between the second layer 96 and the electrical conduction plate 99 in a liquid-tight manner. Hence, the negative-electrode liquid 97 can be restrained from leaking from the negative electrode chamber. Hence, the long-term stability and reliability of the charge cell 78 can be improved.

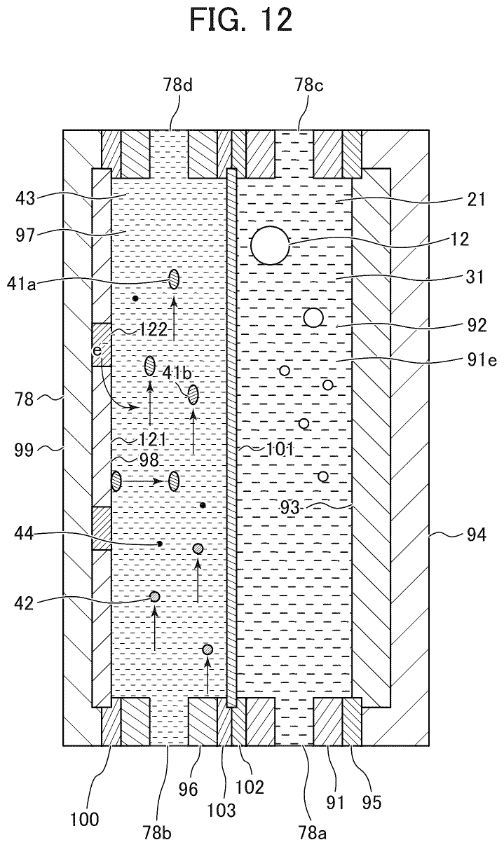

FIG. 12 is a schematic cross-sectional view of a charge cell included in a metal-air flow battery in accordance with a fourth variation example of Embodiment 1.

In the fourth variation example of Embodiment 1, referring to FIG. 12, the negative electrode 98 includes a first portion 121 composed of a first ingredient and a second portion 122 composed of a second ingredient. The second ingredient has a lower hydrogen overvoltage than the first ingredient. Hence, gaseous hydrogen is readily produced on the second portion 122. The produced gaseous hydrogen facilitates detaching the reduced negative-electrode active material particles 41a from the negative electrode 98 and ejecting the detached reduced negative-electrode active material particles 41a from the charge cell 78, as described above. The first ingredient includes, for example, at least one species selected from the group consisting of carbon, copper, and magnesium. The second ingredient includes, for example, nickel.

### 1.18 Experimental Charging

### Experimental Charging 1

As Example 1, the charge cell 78 shown in FIG. 3 was fabricated, and experimental charging was performed using the fabricated charge cell 78.

The negative electrode 98 was made of carbon. In addition, The part of the negative electrode 98 that was immersed in the negative-electrode liquid 97 had dimensions of 10 mm×80 mm.

The positive electrode 93 was a nickel porous body (Celmet®) manufactured by Sumitomo Electric Industries, Ltd.). The part of the positive electrode 93 that was immersed in the positive-electrode liquid 92 had dimensions of 10 mm×80 mm.

The structure other than the negative electrode 98 and the positive electrode 93 was as follows.

Separator 101: “Sheet-shaped Separator, 0.1 mm in thickness, 20 mm×110 mm,” manufactured by Nippon Shokubai Co., Ltd.

Positive-electrode Liquid 92: Zn-saturated KOH aqueous solution, “KOH 29.2%, zinc oxide 4%”

Negative-electrode Liquid 97: Zn-saturated KOH aqueous solution, “KOH 29.2%, zinc oxide 4%, thickening agent 1%”. Here, the viscosity of the negative-electrode liquid was evaluated using a VT-06 manufactured by Rion Co., Ltd. The result was 100 mPasec.

The charge cell of Comparative Example 1 had the same structure as the charge cell 78 of Example 1, except for the negative-electrode liquid 97. The negative-electrode liquid 97 of Comparative Example 1 was as follows.

Negative-electrode Liquid 97: Zn-saturated KOH aqueous solution, “KOH 29.2%, zinc oxide 4%”. Here, the viscosity of the negative-electrode liquid was evaluated using a Ubbelohde viscometer. The result was 2 mPasec.

The positive-electrode liquid 92 and the negative-electrode liquid 97 were distributed in the charge cell 78 of Example 1 and in the charge cell of the comparative example for experimental charging. In the experimental charging, the battery was charged with a constant current with a current density of 100 mA/cm² (per unit projected area of the negative electrode 98). A battery tester (SPEC20526-PFX2011S manufactured by Kikusui Electronics Corp) was used in measurement. In the experimental charging, the reduced negative-electrode active material (metal zinc) particles 41a detached from the negative electrode 98 and ejected from the charge cell 78 of Example 1 and the charge cell of the comparative example were weighed, and the zinc recovery ratio with respect to the applied electricity quantity was calculated. Results of the calculation are shown in Table 1.

$$Zinc Recovery Ratio ( \% ) = Weight of Ejected Zinc ( g ) \times 0.82 ( Ah / g : Specific Capacitance of Zinc ) / Applied Electricity Quantity ( Ah ) \times 100$$

TABLE 1

| | | | Comparative |
|---|---|---|---|
| | Example 1 | Example 2 | Example 1 |
| Zinc Recovery Ratio (%) at | 68 | 94 | 0 |
| Current Density of 100 mA/cm² | | | |

As shown in Table 1, when the negative-electrode liquid 97 has a low viscosity (Comparative Example 1), no reduced negative-electrode active material (metal zinc) particles 41a are ejected from the charge cell. This is because the drag force exerted on the reduced negative-electrode active material (metal zinc) particles 41a when the negative-electrode liquid 97 acts on the reduced negative-electrode active material (metal zinc) particles 41a decreases.

On the other hand, when the negative-electrode liquid 97 has a high viscosity (Example 1), the reduced negative-electrode active material (metal zinc) particles 41a are readily ejected from the charge cell 78. This is because the drag force exerted on the reduced negative-electrode active material (metal zinc) particles 41a when the negative-electrode liquid 97 acts on the reduced negative-electrode active material (metal zinc) particles 41a increases.

### Experimental Charging 2

As Example 2, a charge cell 78 that had the same structure as the charge cell 78 of Example 1, except for the negative-electrode liquid 97, was used in experimental charging. The negative-electrode liquid 97 of Example 2 was as follows.

Negative-electrode Liquid 97: Zn-saturated KOH aqueous solution “KOH 29.2%, zinc oxide 4%, thickening agent 1%, indium hydroxide 0.01%”. Here, the viscosity of the negative-electrode liquid was evaluated using a VT-06 manufactured by Rion Co., Ltd. The result was 100 mPasec.

As shown in Table 1, when the negative-electrode liquid 97 has a high viscosity, and there is an additional component (indium ions), the recovery ratio of the reduced negative-electrode active material (metal zinc) particles 41a ejected from the charge cell 78 is improved. This is because the adherence of the reduced negative-electrode active material (metal zinc) particles 41a to the negative electrode 98 decreases. Therefore, when the negative-electrode liquid 97 has a high viscosity, and there is an additional component (indium ions), it becomes even easier to detach the reduced negative-electrode active material (zinc) particles 41a from the negative electrode 98 and eject the detached reduced negative-electrode active material (metal zinc) particles 41a from the charge cell 78.

### Experimental Charging 3

As Example 3, a charge cell 78 that was the same as the charge cell 78 of Example 2 was used in experimental charging. The positive-electrode liquid 92 and the negative-electrode liquid 97 were also the same as the positive-electrode liquid 92 and the negative-electrode liquid 97 of Example 2 respectively, and specifically were as follows.

Positive-electrode Liquid 92: Zn-saturated KOH aqueous solution “KOH 29.2%, zinc oxide 4%”

Negative-electrode Liquid 97: Zn-saturated KOH aqueous solution “KOH 29.2%, zinc oxide 4%, thickening agent 1%, indium hydroxide 0.01%”. Here, the viscosity of the negative-electrode liquid was evaluated using a VT-06 manufactured by Rion Co., Ltd. The result as 100 mPasec.

In Experimental Charging 3, the battery was charged with a constant current with a different current density (per unit projected area of the negative electrode 98). In the experimental charging, the reduced negative-electrode active material (metal zinc) particles 41a detached from the negative electrode 98 and ejected from the charge cell 78 were weighed, and the zinc recovery ratio with respect to the applied electricity quantity was calculated. Results of the calculation are shown in Table 2.

TABLE 2

Example 3

| | | | | | |
|---|---|---|---|---|---|
| Current Density (mA/cm²) | 30 | 50 | 75 | 100 | 150 |
| Zinc Recovery Ratio (%) | 0 | 58 | 90 | 94 | 59 |

Table 2 indicates a range of preferred current densities (per unit projected area of the negative electrode 98) in which the recovery ratio of the reduced negative-electrode active material (metal zinc) particles 41a ejected from the charge cell can be increased. When the current density (per unit projected area the negative electrode 98) is low (e.g., 30 mA/cm² or 50 mA/cm²), it is difficult to detach the reduced negative-electrode active material (metal zinc) particles 41a from the negative electrode 98. This is because the reduced negative-electrode active material (metal zinc) particles 41a can readily grow densely on the negative electrode 98, and the drag force exerted on the reduced negative-electrode active material (metal zinc) particles 41a when the negative-electrode liquid 97 acts on the reduced negative-electrode active material (metal zinc) particles 41a decreases.

On the other hand, when the current density (per unit projected area of the negative electrode 98) is high (e.g., 150 mA/cm²), it is easy to detach the reduced negative-electrode active material (metal zinc) particles 41a from the negative electrode 98, but a hydrogen-producing reaction that competes against the reduction reaction by which the reduced negative-electrode active material (metal zinc) particles 41a are produced occurs, and therefore, the zinc recovery ratio is reduced.

### 1.19 Charge Cell Stack

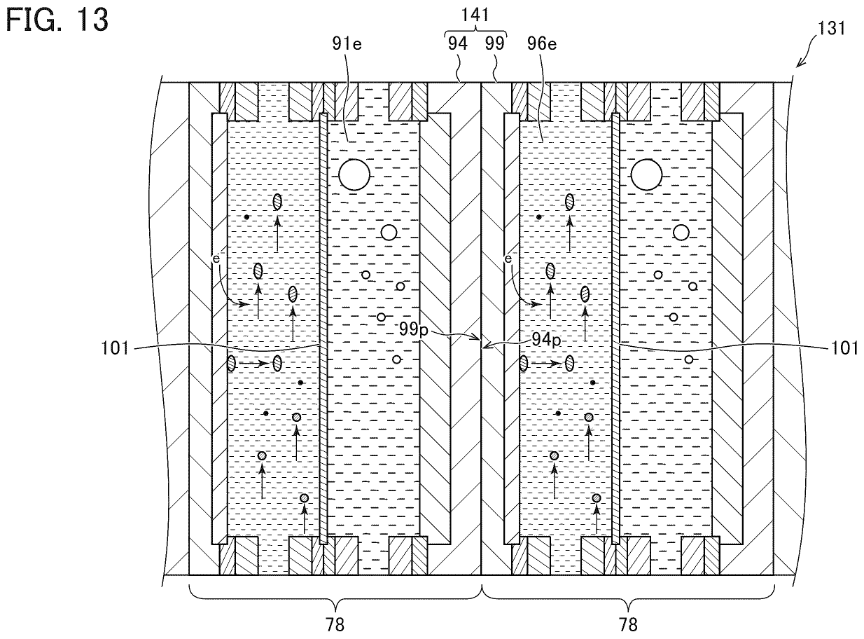

FIG. 13 is a schematic cross-sectional view of a charge cell stack that can be used in place of the charge cell included in the metal-air flow battery in accordance with Embodiment 1.

A charge cell stack 131 shown in FIG. 13 includes a plurality of charge cells 78.

The plurality of charge cells 78 are stacked to form an assembled battery. This particular configuration can increase the electric power with which the charge cell stack 131 can charge a battery beyond the electric power with which one charge cell 78 can charge a battery.

The plurality of charge cells 78 include two mutually adjacent charge cells 78. A main face 94p of the electrical conduction plate 94 of one of the two mutually adjacent charge cells 78 is in contact with a main face 99p of the electrical conduction plate 99 of the other one of the two mutually adjacent charge cells 78. Hence, the electrical conduction plate 94 and the electrical conduction plate 99 are electrically connected to each other, thereby forming a bipolar plate 141 that functions as both a positive-electrode electrical conduction plate and a negative-electrode electrical conduction plate. Hence, the plurality of charge cells 78 are electrically connected in series.

A positive electrode chamber is formed between the bipolar plate 141 and the separator 101 in one of the two charge cells 78. A negative electrode chamber is formed between the bipolar plate 141 and the separator 101 in the other charge cell 78. The positive electrode chamber includes a first flow path 91e formed therein. The negative electrode chamber includes a second flow path 96e formed therein. The positive-electrode liquid 92 is caused to flow in parallel into the plurality of formed first flow path 91e. The negative-electrode liquid 97 is caused to flow in parallel into the plurality of formed second flow path 96e.

The present disclosure is not limited to the description of the embodiments and examples above. Any structure detailed in the embodiments and examples may be replaced by a practically identical structure, a structure that delivers practically the same effect and function, or a structure that achieves practically the same purpose.

What is claimed is:

1. A metal-air flow battery charging cell comprising:
a first layer including a first flow path formed therein;
a positive electrode facing the first flow path;
a second layer including a second flow path formed therein;
a negative electrode facing the second flow path;
a separator configured to separate the first flow path and the second flow path from each other;
a positive-electrode liquid that flows in the first flow path, the positive-electrode liquid having a first viscosity; and
a negative-electrode liquid that flows in the second flow path, the negative-electrode liquid having a second viscosity that is higher than the first viscosity.

2. The metal-air flow battery charging cell according to claim 1, wherein
gaseous oxygen is produced in a reaction on the positive electrode, and
negative-electrode active material particles are produced in a reaction on the negative electrode.

3. The metal-air flow battery charging cell according to claim 1, wherein
the positive-electrode liquid contains a first electrolytic solution, and
the negative-electrode liquid contains a second electrolytic solution and negative-electrode active material ions dissolved in the second electrolytic solution.

4. The metal-air flow battery charging cell according to claim 3, wherein the negative-electrode liquid contains a thickening agent.

5. The metal-air flow battery charging cell according to claim 1, wherein the negative-electrode liquid contains zinc ions and at least one species of ions selected from the group consisting of Group 13 metal elements, Group 14 metal elements, and Group 15 metal elements.

6. The metal-air flow battery charging cell according to claim 1, wherein the negative-electrode liquid contains zinc ions and indium ions.

7. The metal-air flow battery charging cell according to claim 1, wherein the separator is an anionic exchange film, a hydrous gel film, or a film of a plurality of inorganic ionic conductor particles and a resin with which grain boundaries of the plurality of inorganic ionic conductor particles are impregnated.

8. The metal-air flow battery charging cell according to claim 1, wherein
the positive electrode contains nickel, and
the negative electrode contains at least one species selected from the group consisting of carbon, copper, and magnesium.

9. The metal-air flow battery charging cell according to claim 1, further comprising an electrical conduction plate formed integral to the negative electrode.

10. The metal-air flow battery charging cell according to claim 1, further comprising an electrical conduction plate formed integral to the negative electrode and the second layer.

11. The metal-air flow battery charging cell according to claim 1, wherein the first flow path includes a portion configured to guide the positive-electrode liquid in a vertical direction, the metal-air flow battery charging cell further comprising a mechanism configured to generate a flow of the positive-electrode liquid from an underside toward a topside in terms of the vertical direction in the portion.

12. The metal-air flow battery charging cell according to claim 1, wherein the second flow path includes a portion configured to guide the negative-electrode liquid in a vertical direction, the metal-air flow battery charging cell further comprising a mechanism configured to generate a flow of the negative-electrode liquid from an underside toward a topside in terms of the vertical direction in the portion.
